(19) United States
(12) Patent Application Publication
(10) Pub. No.: US 2007/0167272 A1
(43) Pub. Date: Jul. 19, 2007

(54) Differential device for vehicle

(75) Inventors: Noboru Higano, Kanuma-Shi (JP); Hideyuki Inose, Kanuma-shi (JP)

Correspondence Address: MORRISON & FOERSTER, LLP, 555 WEST FIFTH STREET, SUITE 3500, LOS ANGELES, CA, 90013-1024, US

(73) Assignee: GKN Driveline Torque Technology KK, Tochigi-Shi (JP)

(21) Appl. No.: 11/654,141

(22) Filed: Jan. 16, 2007

(30) Foreign Application Priority Data
Jan. 19, 2006 (JP) 2006-011642
Aug. 2, 2006 (JP) 2006-211020

(51) Int. Cl. F16H 48/06

(52) U.S. Cl. 475/248

(57) ABSTRACT

A differential device is equipped with differential gears 3 and a pair of output gears 5, 7 that mesh with the differential gears 3 in different meshing pitch-circle radii R1, R2. The output gears 5, 7 are formed by contrate gears, while the differential gears 3 are formed by spur gears.

### BACKGROUND OF THE INVENTION

1. Field of the Invention

The present invention relates to a differential device for a vehicle.

2. Description of the Related Art

In prior art, Japanese Patent Laid-open Publication No. H01-275934 discloses a bevel-gear type differential device. In this differential device, a pair of side gears (output gears) are arranged so as to mesh with pinion gears (differential gears) in the same pitch-circle radii and therefore, the same differential device is called to as “equal-torque distribution (ratio) type differential device” that distributes equal driving torques to left wheels and right wheels.

In order to adopt the above-mentioned “bevel-gear type” differential device as a center differential (i.e. differential device distributing a driving force of a motor to front wheels and rear wheels) and further distribute the driving forced to the front and rear wheels with different torques (i.e. by an unequal-torque distribution ratio), it is necessary to establish a situation where one side gear on one side and another side gear on the other side mesh with the pinion gears in different meshing pitch-circle radii from each other.

Conventionally, such a situation where the side gears mesh with the pinion gears in different meshing pitch-circle radii has been accomplished by arranging a pinion shaft carrying the pinion gears at a slant (out of perpendicular) to a rotating axis of the differential device.

### SUMMARY OF THE INVENTION

In order to arrange the pinion shaft at a slant to the rotating shaft of the differential device, however, there is required at least one of the following measures of: (1) providing a differential casing with a special supporting structure for carrying the pinion shaft at a slant; (2) providing the slanted pinion shaft with a special supporting structure for carrying the pinion gears; and (3) providing a thrust block for supporting inner ends of the pinion shaft.

In these measures, it is required to machine supporting parts or supporting members for realizing the above-mentioned structures, with high accuracy. Additionally, these measures are accompanied with troublesome and complicated gear cutting for the pinion gears and the side gears. Consequently, the resulting differential device would have a complicated structure causing a high manufacturing cost.

Under a situation mentioned above, an object of the present invention is to provide a differential device that eliminates the need for a special supporting structure for the pinion shaft and the pinion gears and that does not require high accuracy in processing components of the differential device. Additionally, another object of the present invention is to provide a differential device having a simple structure, which allows a distribution ratio of the driving torque to be established at a low cost.

According to the present invention, there is provided a differential device for a vehicle, comprising: differential gears to which a driving torque of a motor is inputted; and a pair of output gears that mesh with the differential gears to distribute the driving torque inputted from the differential gears to vehicle wheels, wherein the differential device is constructed so as to allow respective meshing pitch-circle radii of the output gears meshing with the differential gears to be changeable in compliance with a desired distribution ratio of the driving torque to be transmitted to the vehicle wheels.

### BRIEF DESCRIPTION OF THE DRAWINGS

FIG. 1 is a sectional view showing a center differential in accordance with a first embodiment of the present invention;

FIG. 2 is a sectional view taken along a line II-II of FIG. 1;

FIG. 3 is a sectional view showing a center differential in accordance with a second embodiment of the present invention;

FIG. 4 is a schematic view showing a power system of a vehicle equipped with an engine in horizontal arrangement; and

FIG. 5 is a schematic view showing a power system of a vehicle equipped with an engine in longitudinal arrangement.

### DETAILED DESCRIPTION OF THE PREFERRED EMBODIMENTS

Embodiment of the present invention will be described with reference to accompanying drawing, in detail.

### 1^{st}. Embodiment

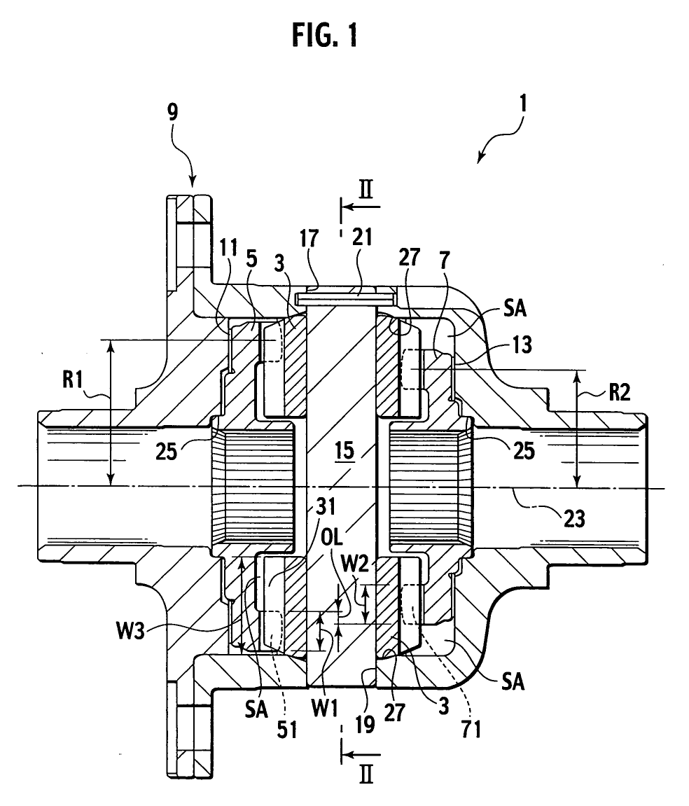

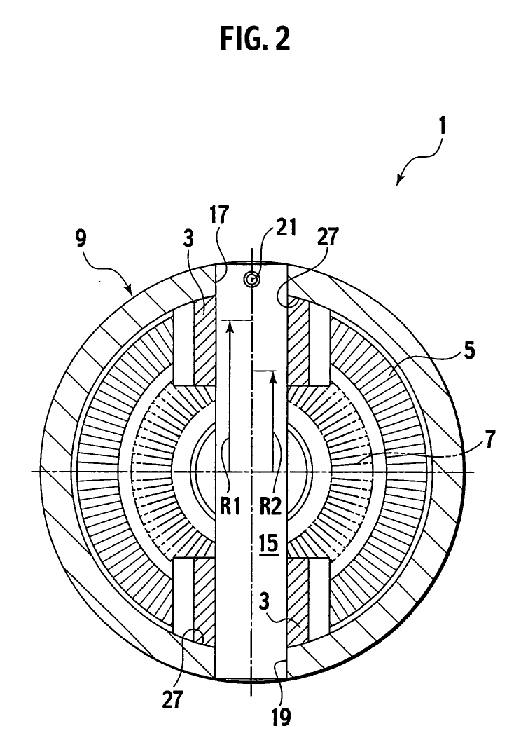

Referring to FIGS. 1 and 2, we now explain a differential device in accordance with a first embodiment of the present invention. This differential device is embodied in the form of a center differential 1 shown in FIGS. 1 and 2.

[Feature of the Center Differential 1]

The center differential 1 is constructed so as to distribute a driving torque of an engine (as a motor in the invention) to vehicle wheels through the intermediary of spur pinion gears 3, 3 (as differential gears) and a pair of side gears 5, 7 (as output gears) succeeding to the pinion gears 3, 3. The side gear 5 engages (meshes) with the pinion gears 3, 3 in one meshing pitch-circle radius (R1), while the other side gear 7 meshes with the pinion gears 3, 3 in another meshing pitch-circle radius (R2). This center differential 1 is characterized by allowing respective meshing pitch-circle radii (R1, R2) of the side gears 5, 7 meshing with the differential gears 3, 3 to be established (changeable) in compliance with a desired distribution ratio of the driving torque to be transmitted to the vehicle wheels.

According to the first embodiment, the center differential 1 is constructed so that the side gears 5, 7 mesh with the pinion gears 3, 3 in different meshing pitch-circle radii (R1, R2), respectively. In detail, it is established so that the meshing pitch-circle radius (R1) where the side gear 5 meshes with the pinion gears 3, 3 becomes larger than the other meshing pitch-circle radius (R2) where the other side gear 7 meshes with the pinion gears 3, 3. Thus, the relationship between the radii R1 and R2 is expressed by an inequality of “R1>R2”.

In the shown embodiment, a pair of contrate gears are used for the side gears 5, 7, while a pair of spur gears are used for the pinion gears 3, 3. A contrite gear is also called a “face gear” that is a disc-like gear meshing with a spur gear in its facing direction. The contrate gear forming the side gear 5 has a number of gearing teeth formed in the circumferential direction of the side gear 5. These gearing teeth constitute one gearing teeth part 51. The gearing teeth part 51 is formed with a teeth width (W1) in the radial direction of the side gear 5. Note that the teeth width will be referred to as “face width (W1)”, hereinafter. Similarly, the other contrate gear forming the side gear 7 has a number of gearing teeth formed in the circumferential direction of the side gear 7. These gearing teeth constitute another gearing teeth part 71. The gearing teeth part 71 is formed with a teeth width (W2) in the radial direction of the side gear 7. Note that the teeth width will be referred to as “face width (W2)”, hereinafter.

Despite that the side gears 5, 7 mesh with the pinion gears 3, 3 in the different meshing pitch-circle radii (R1, R2), the side gears 5, 7 are arranged in the differential casing 9 so that their respective gearing teeth parts 51, 71 of the face widths (W1, W2) overlap each other in the radial direction of the side gears 5, 7. In other words, an axial projection of the gearing teeth part 51 (face width: W1) projected on an imaginary plane perpendicular to a rotating axis 23 of the center differential 1 overlaps another axial projection of the gearing teeth part 71 (face width: W2) projected on the same imaginary plane perpendicular to the rotating axis 23. Note that this overlapping part between the gearing teeth parts 51, 71 will be referred to as “radial overlapping part OL”, hereinafter.

In arrangement, the radial overlapping part OL is positioned close to an axial midpoint of a gearing teeth part 31 (face width: W3) of one pinion gear 3 meshing with the side gears 5, 7.

The pinion gears 3, 3 and the side gears 5, 7 are accommodated in a differential casing 9 (as an accommodating member in the invention). In operation, the differential casing 9 is driven in rotation by the driving torque of the engine. The pinion gears 3, 3 rotate integrally with the differential casing 9. The center differential 1 is further characterized by a large-diametral washer 11 (as one sliding member in the invention) between the differential casing 9 and the side gear 5 and a small-diametral washer 13 (as another sliding member) between the differential casing 9 and the side gear 7. These washers 11, 13 serve to limit a differential motion between the front wheels and the rear wheels, owing to sliding resistances produced on receipt of respective meshing reactive forces of the side gears 5, 7.

Further, the differential casing 9 is provided with an accommodating space SA for the so-formed side gears 5, 7 in engagement with the pinion gears 3, 3. This accommodating space SA allows the meshing pitch-circle radii (R1, R2) of the side gears 5, 7 to be variably adjusted within a range of the face width (W3) of the pinion gear 3. Consequently, if required to change the distribution ratio of driving torque against the wheels to a desired distribution ratio, the differential casing 9 of the center differential 1 has only to contain a pair of side gears 5, 7 in a manner that they mesh with the pinion gears 3, 3 in respective meshing pitch-circle radii measured up to the desired distribution ratio. Owing to the provision of the accommodating space SA, even if altering the distribution ration of driving torque, there is no need to replace the pinion gears 3, 3 and the differential casing 9 with the other ones. In other words, the pinion gear 3, 3 and the differential casing 9 can be handled as changeless common components throughout the production of center differentials.

[Constitution of the Center Differential 1]

The pinion gears 3, 3 are rotatably supported on both axial ends of a pinion shaft 15, each end by one gear. The above-mentioned face width (W3) is established so as to have an extent (length) enough to mesh with the large-diametral side gear 5 and the small-diametral side gear 7. The pinion shaft 15 is assembled into the different casing 9 while passing through through-holes 17, 19. Again, the pinion shaft 15 is prevented from dropping out of the differential casing 9 by a spring pin 21. The spring pin 21 is arranged in the differential casing 9 so as to penetrate one end portion of the pinion shaft 15. The pinion shaft 15 is arranged so as to be perpendicular to the rotating axis 23 of the center differential 1 (the differential casing 9).

The side gears 5, 7 are rotatably supported by supporting parts 25, 25 formed in the differential casing 9. The large-diametral side gear 5 meshing with the pinion gears 3 in the meshing pitch-circle radius R1 is associated with either the front wheels or the rear wheels through an axle connected in spline with the side gear 5. On the other hand, the small-diametral side gear 7 meshing with the pinion gears 3, 3 in the meshing pitch-circle radius R2 is associated with the remaining ones of the front wheels and the rear wheels through another axle connected in spline with the side gear 7. The differential casing 9 has circumferential bearing parts 27, 27 formed to allow the pinion gears 3, 3 to slide thereon. In operation, these bearing parts 27, 27 are adapted so as to receive centrifugal forces of the pinion gears 3, 3 in revolution.

Each tooth flank of the side gears 5, 7 and the pinion gears 3, 3 is subjected to crowning or tiny chamfering to lighten occurrence of noise and vibration caused by both pairs of gears (i.e. one pair of the side gear 5 and the pinion gears 3, 3 and another pair of the side gear 7 and the pinion gears 3, 3) and propagation noise and vibration between the pairs. The pinion gears 3, 3 and the side gears 5, 7 are produced by means of gear-cutting, forging and so on.

The engine's driving force for rotating the differential casing 9 is transmitted from the pinion shaft 15 to the side gears 5, 7 through the pinion gears 3, 3. The so-transmitted driving force is distributed to the front wheels and the rear wheels via the above axles in spline connection.

Then, a differential rotation between the front wheels and the rear wheels is limited by limited-slip torques (sliding resistances) produced since the washers 11, 13 are pressed on the differential casing 9 by the meshing reactive forces of the side gears 5, 7. Owing to the limited-slip effect, it is possible to improve both vehicle's traveling ability and stability. Additionally, if given two kinds of washers 11, 13 having different diameters, then it is possible to make a limited-slip torque applied on the front wheels different from another limited-slip torque applied on the rear wheels. According to the embodiment, therefore, it is possible to control a ratio of the limited-slip torque on the front wheels and the limited-slip torque on the rear wheels against a wide variety of vehicles in view of enhancing their traveling abilities and stabilities.

[Effect of the Center Differential 1]

As mentioned above, since the center differential 1 of the embodiment is constructed so as to allow the meshing pitch-circle radii (R1, R2) of the side gears 5, 7 meshing with the pinion gears 3, 3 to be established corresponding to a desired distribution ratio of the driving torque applied on the front wheels to the driving torque applied on the rear wheels, it is possible to increase a driving torque to be transmitted to ones of the front and rear wheels while decreasing another driving torque to be transmitted to the others of front and rear wheels. Further, if the center differential 1 is designed so as to equalize respective driving torques to be transmitted to the front wheels and the rear wheels, the center differential 1 would be applicable to a “wheel” differential (e.g. front differential device, rear differential device).

By making the meshing pitch-circle radius R1 of the side gear 5 larger while reducing the meshing pitch-circle R2 of the side gear 7, the center differential 1 can transmit different driving torques to the front wheels and the rear wheels. Additionally, such a structure of the center differential 1 can be embodied at a remarkably-low price.

It should be noted that the above-mentioned effect is realized by only meshing the side gears 5, 7 with the pinion gears 3, 3 in different pitch-circle radii R1, R2. Different from a conventional structure where the pinion shaft is arranged on the slant, accordingly, there is no need to provide any particular structure to support the pinion shaft 15 and the pinion gears 3, 3, establishing nonnecessity of high accuracy in processing components and gear cutting. Thus, the resulting structure is simplified with a remarkable reduction in manufacturing cost.

According to the embodiment, by adopting since spur gears for the pinion gears 3, 3 and contrate gears for the side gears 5, 7, if only broadening the face width W3 of each pinion gear 3, then it becomes possible to alter the meshing pitch-circle radii R1, R2 of the side gears 5, 7 with ease, bringing about the above-mentioned effect at a remarkably low cost.

Still further, by allowing the axial projections of the gearing teeth parts 51, 71 (face widths: W1, W2) of the side gears 5, 7 to overlap each other and additionally allowing respective side gears' portions meshing with the pinion gears 3, 3 to overlap each other at the overlapping part OL, it is possible to reduce respective tipping torques of the pinion gears 3, 3, establishing normal meshing conditions between the pinion gears 3, 3 and the side gears 5, 7.

Additionally, by positioning the overlapping part OL in the vicinity of the axial midpoint of the gearing teeth part 31 (face width: W3) of each pinion gear 3, the tipping torque of the pinion gear 3 is reduced furthermore, improving respective meshing conditions between the gears 3, 3 and the side gears 5, 7 and their toughness (durability).

Again, by arranging the different-diametral washers 11, 13 between the differential casing 9 and the side gears 5, 7, different limited-slip forces between the front wheels' side and the rear wheels' side can be realized with ease.

### 2^{nd}. Embodiment

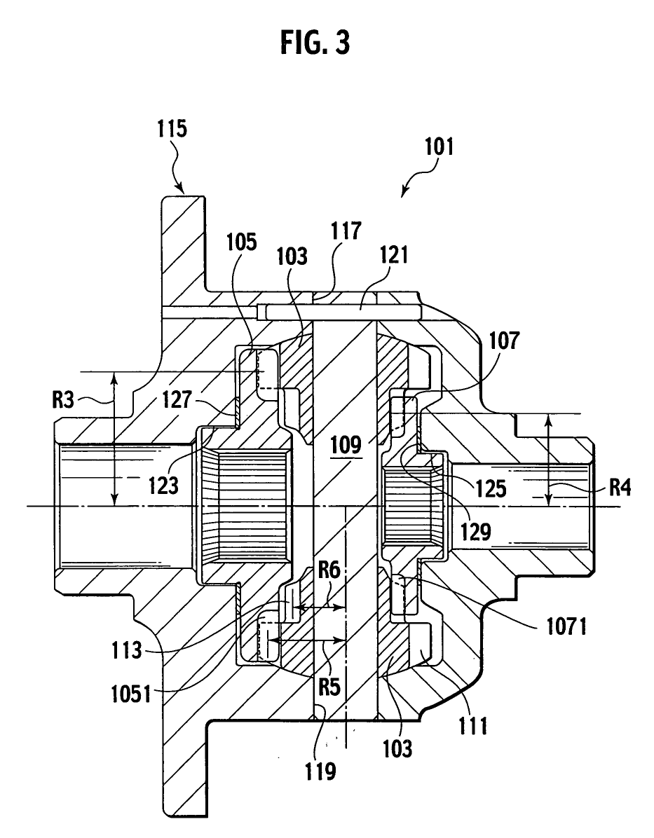

Referring to FIGS. 3 to 5, we now describe a center differential 101 (as the differential device in the invention) in accordance with a second embodiment of the present invention.

[Feature of the Center Differential 101]

The center differential 101 is a differential device that distributes a driving torque of an engine (motor) to vehicle wheels through pinion gears 103, 103 (as the differential gears in the invention) and a pair of side gears 105, 107 (as the output gears). In the center differential 101, the pinion gears 103, 103 mesh with the side gear 105 in one meshing pitch-circle radius (R3), while the same pinion gears 103, 103 mesh with the other side gear 107 in another meshing pitch-circle radius (R4) different from the former radius (R3). In detail, it is established so that the meshing pitch-circle radius (R3) where the side gear 105 meshes with the pinion gears 103, 103 becomes larger than the other meshing pitch-circle radius (R4) where the other side gear 107 meshes with the side gears 103, 103. Thus, the relationship between the radii R3 and R4 is expressed by an inequality of “R3>R4”.

[Constitution of the Center Differential 101]

As shown in FIG. 3, the pinion gears 103, 103 are rotatably supported on both ends of a pinion shaft 109, each end by one gear, two pinion gears in total. Each of the pinion gears 103, 103 is provided with two gearing teeth parts 111, 113. The gearing teeth part 111 is formed so as to have a meshing pitch-circle radius R5, while the gearing teeth part 113 is formed so as to have another meshing pitch-circle radius R6 different from the former radius R5. The side gear 105 has a number of gearing teeth formed in the circumferential direction to constitute a gearing teeth part 1051. Similarly, the other side gear 107 has a number of gearing teeth formed in the circumferential direction to constitute another gearing teeth part 1071. The gearing teeth part 111 of the pinion gear 103 meshes with the gearing teeth part 1051 of the large-diametral side gear 105 in the larger meshing pitch-circle radius R3. While, the other teeth part 113 of the pinion gear 103 meshes with the gearing teeth part 1071 of the small-diametral side gear 107 in the smaller meshing pitch-circle radius R4. As for the pinion gear 103, the gearing teeth parts 111, 113 may be formed by means of gear-cutting or forging a single base substance. Alternatively, the pinion gear 103 may be produced by joining two components to each other. Then, one component is formed by a base substance having the gearing teeth part 111, while another component is formed by another base substance having the gearing teeth part 113. The pinion shaft 109 is assembled into the different casing 115 while passing through through-holes 117, 119. The pinion shaft 109 is also prevented from dropping out of the differential casing 115 by a spring pin 121. The spring pin 121 is arranged in the differential casing 115 so as to penetrate one end portion of the pinion shaft 109.

The side gears 105, 107 are rotatably supported by supporting parts 123, 125 formed in the differential casing 115. Again, the gearing teeth part 1051 of the large-diametral side gear 105 meshes with each pinion gear 103 through the gearing teeth part 111 in the meshing pitch-circle radius R3. The gearing teeth part 111 is formed in the circumferential direction of the pinion gear 103 in the larger meshing pitch-circle radius R5. A large-diametral washer 127 is arranged between the side gear 105 and the differential casing 115.

On the contrary, the gearing teeth part 1071 of the small-diametral side gear 107 meshes with the gearing teeth part 113 of each pinion gear 103 in the meshing pitch-circle radius R4. The gearing teeth part 113 is formed in the circumferential direction of the pinion gear 103 in the smaller meshing pitch-circle radius R6. A large-diametral washer 129 is arranged between the side gear 107 and the differential casing 115.

In the center differential 101 constructed above, the driving force of an engine rotating the differential casing 115 is transmitted from the pinion shaft 109 to the side gears 105, 107 through the pinion gears 103 and sequentially distributed to the front wheels and the rear wheels through axle shafts.

Then, the washers 127, 129 are pressed on the differential casing 9 by meshing reactive forces of the side gears 105, 107, producing limited-slip torques (sliding resistances). Consequently, a differential rotation between the front wheels and the rear wheels is limited by the limited-slip torques. Owing to the limited-slip effect, it is possible to improve both vehicle's traveling ability and stability. Additionally, if given two kinds of washers 127, 129 having different diameters, then it is possible to make a limited-slip torque applied on the front wheels different from another limited-slip torque applied on the rear wheels. According to the embodiment, therefore, it is possible to control a ratio of the limited-slip torque on the front wheels and the limited-slip torque on the rear wheels against a wide variety of vehicles in view of enhancing their traveling abilities and stabilities.

Now, in case of the meshing pitch-circle radii R3, R4, the specifications of the side gears 105, 107 in pairs and the teeth parts 111, 113 of the pinion gear 103 are established as follows.

Assume, the large-diametral side gear 105 is characterized by module: ms1; number of teeth: zs1; and pitch-circle diameter: ds1, while the small-diametral side gear 107 is characterized by module: ms2; number of teeth: zs2; and pitch-circle diameter: ds2. Here, if equating the number of teeth zs1 with the number of teeth zs2 (=zs) in view of establishing an equivalent gear ratio, then the specifications of the side gears 105, 107 are expressed by ds1=ms1×zs and ds2=ms2×zs.

Assume as well, the teeth part 111 of the pinion gear 103 is characterized by module: mp1; number of teeth: zp1; and pitch-circle diameter: dp1, while the teeth part 113 of the pinion gear 103 is characterized by module: mp2; number of teeth: zp2; and pitch-circle diameter: dp2. Here, if equating the number of teeth zp1 with the number of teeth zp2 (=zp) in view of establishing an equivalent gear ratio, then the specifications of the teeth parts 111, 113 of the pinion gear 103 are expressed by dp1=mp1×zp and dp2=mp2×zp.

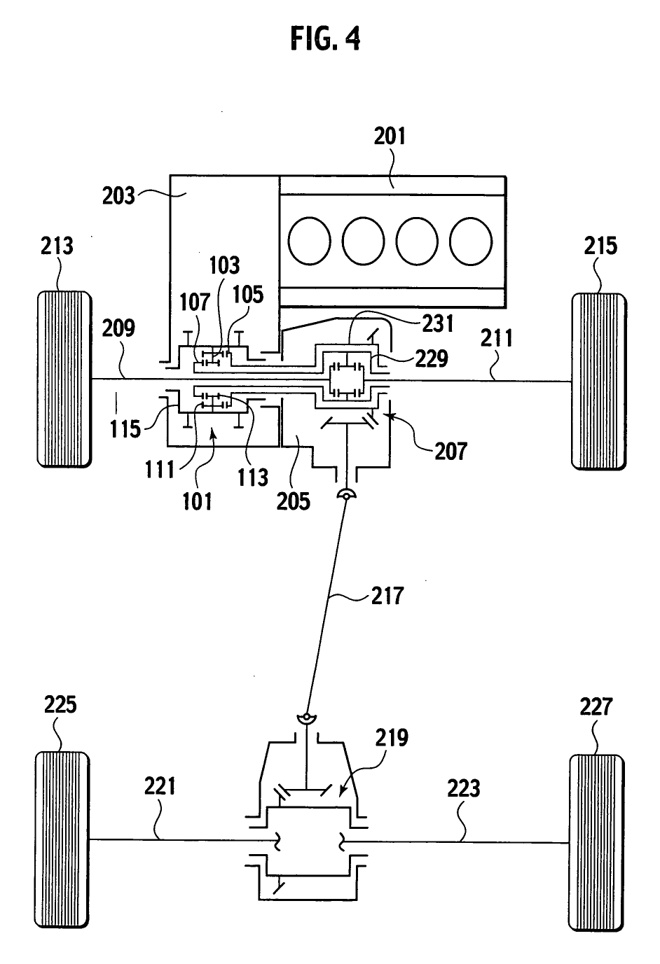

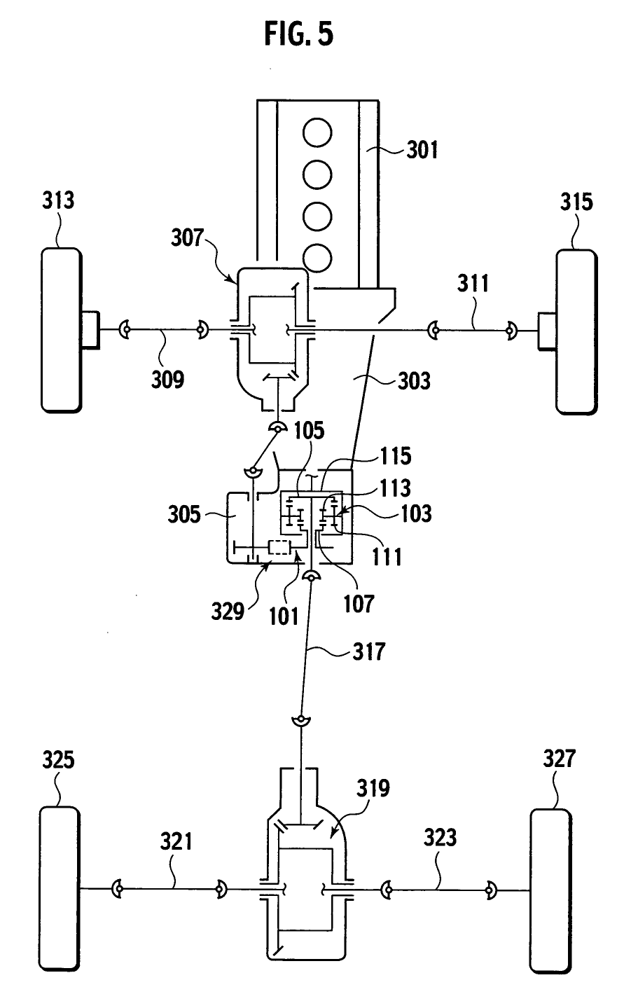

The so-established center differential 101 is applicable to a power system for a vehicle, for example, a vehicle shown in FIG. 4 or FIG. 5.

FIG. 4 shows a power system of a vehicle equipped with the center differential 101 for an engine 201 in lateral arrangement. The power system of this vehicle comprises the engine 201 with a transmission 203, the center differential 101, a transfer 205, a front differential 207, front axles 209, 211, front wheels 213, 215, a propeller shaft (on rear wheels' side) 217, a rear differential 219, rear axles 221, 223, rear wheels 225, 227 and so on.

The driving force of the engine 201 is transmitted from the center differential 101 in the transmission 203 to the front differential 207 in the transfer 205 and sequentially distributed to the front wheels 213, 215 through the front axles 209, 211, respectively. Simultaneously, the driving force is transmitted from the center differential 101 to the rear differential 219 through the intermediary of the front differential 207 and the propeller shaft 217 and sequentially distributed to the rear wheels 225, 227 through the rear axles 221, 223, respectively. The distribution of a driving torque brought from the engine 201 is accomplished by the center differential 101.

In this center differential 101, the small-diametral side gear 107 is connected to an inner casing 229 of the front differential 207, while the large-diametral side gear 105 is connected to an outer casing 231 of the front differential 207. Then, the driving torque inputted to the differential casing 115 is transmitted to the side gears 105, 107 through the pinion gears 103. The driving torque inputted to the small-diametral side gear 107 is distributed to the front wheels 213, 215 through the inner casing 229 of the front differential 207. The driving torque inputted to the large-diametral side gear 105 is transmitted from the outer casing 231 of the front differential 207 to the rear differential 219 through the propeller shaft 217 and further distributed to the rear wheels 225, 227.

In the center differential 101, as the meshing pitch-circle radius R3 of the side gear 105 meshing with the teeth part 111 of the pinion gear 103 is larger than the meshing pitch-circle radius R4 of the side gear 107 meshing with the teeth part 113 of the pinion gear 103 (R3>R4), the driving torque inputted to the large-diametral side gear 105 becomes larger than that inputted to the small-diametral side gear 107. Therefore, in the shown power system, there is established a relationship where the driving torque distributed to the front wheels is smaller than the driving torque distributed to the rear wheels.

FIG. 5 shows a power system of a vehicle equipped with the center differential 101 for an engine 301 in longitudinal arrangement. The power system of this vehicle comprises the engine 301 with a transmission 303, the center differential 101, a transfer 305, a front differential 307, front axles 309, 311, front wheels 313, 315, a propeller shaft (on rear wheels' side) 317, a rear differential 319, rear axles 321, 323, rear wheels 325, 327 and so on.

The driving force of the engine 301 is transmitted from the center differential 101 in the transfer 305 to the front differential 307 and sequentially distributed to the front wheels 313, 315 through the front axles 309, 311, respectively. Simultaneously, the driving force is transmitted from the center differential 101 to the rear differential 319 through the intermediary of the propeller shaft 317 and sequentially distributed to the rear wheels 325, 327 through the rear axles 321, 323, respectively.

In this center differential 101, the small-diametral side gear 107 is connected to a power transmission mechanism 329 on the side of the front differential 307, while the large-diametral side gear 105 is connected to the propeller shaft 317 on the rear wheels' side. Then, the driving torque inputted to the differential casing 115 is transmitted to the side gears 105, 107 through the pinion gears 103. The driving torque inputted to the small-diametral side gear 107 is distributed to the front wheels 313, 315 through the power transmission mechanism 329 and the front differential 307. The driving torque inputted to the large-diametral side gear 105 is transmitted to the rear differential 319 through the propeller shaft 317 and further distributed to the rear wheels 325, 327.

In the center differential 101, as the meshing pitch-circle radius R3 of the side gear 105 meshing with the teeth part 111 of the pinion gear 103 is larger than the meshing pitch-circle radius R4 of the side gear 107 meshing with the teeth part 113 of the pinion gear 103 (R3>R4), the driving torque inputted to the large-diametral side gear 105 becomes larger than that inputted to the small-diametral side gear 107. Therefore, in the shown power system, there is established a relationship where the driving torque distributed to the front wheels is smaller than the driving torque distributed to the rear wheels.

Although the relationship where the driving torque distributed to the front wheels is smaller than the driving torque distributed to the rear wheels is established in the above-mentioned center differential 101, the relationship may be modified in a manner that the driving torque distributed to the front wheels becomes larger than the driving torque distributed to the rear wheels. In such a case, the specifications of the side gears 105, 107 in pairs and the teeth parts 111, 113 of the pinion gear 103 have only to be established so that the meshing pitch-circle radius R3 of the side gear 105 meshing with the teeth part 111 of the pinion gear 103 becomes smaller than the meshing pitch-circle radius R4 of the side gear 107 meshing with the teeth part 113 of the pinion gear 103 (R3<R4). That is, the adjustment of driving torque to be distributed to the front wheels and the rear wheels may be accomplished by establishing the specifications of one pair of side gears and the pinion gears.

It should be noted that the pinion gears and the side gears in common with the center differential 101 and the front differential 207 are formed by contrate gears. Therefore, there is no need to arrange the pinion shaft on the slant and provide any particular structure to support the pinion shaft 109 and the pinion gears 103, 103, establishing nonnecessity of high accuracy in processing components and gear cutting. Thus, the resulting structure is simplified with a remarkable reduction in manufacturing cost.

Additionally, the differential device of FIGS. 1 and 2 in accordance with the first embodiment of the present invention is also applicable to the vehicles shown in FIGS. 4 and 5.

[Effect of the Center Differential 101]

Since each of the pinion gears 103 meshes with the side gears 105, 107 in different meshing pitch-circle radii R3, R4, the pinion gear 103 is provided with the teeth parts 111, 113 having two kinds of specifications. Accordingly, there is no need to form extra teeth in the pinion gear 103, allowing the pinion gear 103 to mesh with the side gears 105, 107 in the minimum number of meshing pitch-circle radii R3, R4 required. Thus, comparing with a situation that the pinion gear has a teeth part formed with one kind of specification (e.g. the pinion gear 3 of the first embodiment), it is possible to provide a compact meshing structure between the pinion gears 103, 103 and the side gears 105, 107 with the reduced meshing pitch-circle radii, as a whole.

Additionally, since the teeth parts 111, 113 of each pinion gear 103 are formed so as to correspond to the side gears 105, 107 respectively, the present invention is applicable to not only the shown combination of the pinion gears with the side gears all in the form of contrate gears but a combination of pinion gears with side gears all in the form of bevel gears, so that it is possible to expand the versatility in establishing the whole differential device.

[Other embodiments within the Scope of the Invention]

Different from the above-mentioned embodiments, the present invention may be modified to a differential device where the meshing pitch-circle radii of one pair of output gears meshing with differential gears are equal to each other. According to the present invention, therefore, it is possible to select either a structure intended to distribute the driving torque of an engine to the front and rear wheels equally or a structure intended to distribute the driving torque of an engine to the front and rear wheels in inequality with ease.

Different from the above-mentioned embodiments, it is not indispensable to allow the gearing teeth parts of two side gears to overlap each other in the radial direction of the side gears. In such a structure that the gearing teeth parts of the side gears do not overlap each other, the distribution ratio of the driving torque could be established larger than the distribution ratios in the shown embodiments.

In order to attain such an unequal torque distribution between one pair of output shafts, alternatively, one pair of output gears having the same pitch-circle diameter may be provided with respective numbers of teeth different from each other. Such a modification would be established by mutually changing both specification ratios and addendum modification coefficients of one pair of output gears meshing with the differential gears.

Further, different from the above-mentioned embodiment, there may be provided a single washer (sliding member) between the differential casing and either of the side gears in pairs.

As mentioned above, since the differential device of the present invention is constructed so as to enable the meshing pitch-circle radii of one pair of output gears to the differential gears to be established depending on the distribution ratio of the driving torque to the wheels, the so-constructed differential device could be utilized as a center differential so as to make the driving torque transmitted to the wheels on one side larger while making the driving torque transmitted to the wheels on the other side smaller. Alternatively, the above differential device may be utilized as a so-called “wheel differential” (i.e. a differential device arranged on either the front wheels' side or the rear wheels' side) so as to equalize the driving torques transmitted to the wheels on both sides.

Further, since one pair of output gears mesh with the differential gears in different meshing pitch-circle radii respectively, the differential device of the present invention is suitable for a center differential constructed so as to transmit different driving torques to vehicle wheels on one side (e.g. front wheels) and vehicle wheels on the other side (e.g. rear wheels). Thus, it is possible to provide such a center differential at a remarkably low cost.

In the differential device of the present invention, the above-mentioned effect is realized by only meshing the respective output gears with the differential gears in different meshing pitch-circle radii. Thus, different from a conventional structure where the pinion shaft is arranged on the slant, accordingly, there is no need to form any particular support structure on either an accommodating member for accommodating the differential device or a support shaft for supporting the pinion gears, whereby the differential device can be provided with a simple structure and a remarkably-reduced manufacturing cost.

In the differential device of the present invention, since one pair of output gears mesh with the differential gears in different meshing pitch-circle radii respectively, each differential gear is provided with respective teeth parts having two kinds of specifications. Accordingly, comparing the so-formed differential gear with a differential gear provided with a teeth part having a single kinds of specification, it is possible to provide compact meshing pitch-circle radii of the differential gears meshing with one pair of output gears, as a whole.

In the differential device of the present invention, since the structure where each differential gear meshes with one pair of output gears in different meshing pitch-circle radii can be provided so long as the teeth part of the differential gear is formed in conformity of the pair of output gears, it is possible to expand the versatility in establishing the whole differential device.

In the differential device of the present invention where contrate gears are employed as one pair of output gears while adopting spur gears as the differential gears, to broaden the face widths of the differential gears allows the meshing pitch-circle radii between the output gears and each differential gear to be varied with ease, the above-mentioned effect can be realized at a low cost.

In the differential device that respective gearing teeth parts of the output gears are arranged so as to overlap each other in the radial direction in order that respective output gears' portions meshing with the differential gears overlap each other, it is possible to reduce respective tipping torques of the output gears with respect to the differential gears that much, whereby respective meshing conditions of all gears (i.e. the differential gears and the output gears) can be maintained normally. Consequently, it is possible to improve the toughness (durability) of gears remarkably.

In the differential device that an overlapping part between two gearing teeth parts of the output gears is positioned close to the midpoint of the gearing teeth part of each differential gear, it is possible to reduce tipping torques of the differential gears furthermore, whereby respective meshing conditions of all gears (i.e. the differential gears and the output gears) and their toughness (durability) can be improved furthermore.

According to the differential device of the present invention, still further, the limited-slip differential forces are effected by friction torques produced in the sliding members arranged between the accommodating member and the output gears, while different driving torques are distributed since the output gears mesh with the differential gears in different meshing pitch-circle radii. Thus, as the friction torques (=frictional force×radius of friction) produced in the respective sliding members are different from each other, it is possible to effect limited-slip differential forces that are different from each other between the wheels on one side and the wheels on the other side, with ease.

Finally, it will be understood by those skilled in the art that the foregoing descriptions are nothing but embodiments and various modifications of the disclosed differential device and therefore, various changes and modifications may be made within the scope of claims.

This application is based upon the Japanese Patent Application No. 2006-011642, filed on Jan. 19, 2006, the entire content of which is incorporated by reference herein.

Wha is claimed is:

1. A differential device for a vehicle, comprising:
differential gears to which a driving torque of a motor is inputted; and
a pair of output gears that mesh with the differential gears to distribute the driving torque inputted from the differential gears to vehicle wheels, wherein
the differential device is constructed so as to allow respective meshing pitch-circle radii of the output gears meshing with the differential gears to be changeable in compliance with a desired distribution ratio of the driving torque to be transmitted to the vehicle wheels.

2. The differential device of claim 1, wherein
the pair of output gears have gearing teeth parts arranged so as to mesh with the differential gears in meshing pitch-circle radii different from each other, each of the gearing teeth parts including a number of gearing teeth formed in a circumferential direction of each of the pair of output gears.

3. The differential of claim 2, wherein
the pair of output gears are formed by contrate gears, while the differential gears are formed by spur gears.

4. The differential device of claim 2, wherein,
the pair of output gears are arranged so that their gearing teeth parts overlap each other in a radial direction thereof.

5. The differential of claim 4, wherein
the pair of output gears are arranged so that their gearing teeth parts overlap each other in the vicinity of respective midpoints of the gearing teeth parts of the differential gears in the radial direction.

6. The differential device of claim 1, further comprising:
an accommodating member allowing the differential gears to rotate due to the driving torque of the motor; and
a sliding member arranged between the accommodating member and at least one of the pair of output gears to limit a differential motion between the wheels due to sliding resistances produced on receipt of a meshing reactive forces of the at least one output gear.

7. The differential device of claim 1, further comprising:
an accommodating member allowing the differential gears to rotate due to the driving torque of the motor; and
a pair of sliding members arranged between the accommodating member and the pair of output gears to limit a differential motion between the wheels due to sliding resistances produced on receipt of meshing reactive forces of the pair of output gears, wherein
the pair of sliding members are formed so as to slide in different sliding radii from each other.

8. The differential device of claim 1, further comprising:
an accommodating member allowing the differential gears to rotate due to the driving torque of the motor, wherein
the accommodating member is provided with an accommodating space which is formed with a length corresponding to face widths of the differential gears in a diametral direction thereby allowing an accommodation of the pair of output gears.
